(19) United States
(12) Patent Application Publication
(10) Pub. No.: US 2011/0150741 A1
(43) Pub. Date: Jun. 23, 2011

(54) PRODUCTION OF SILICON BY REACTING SILICON OXIDE AND SILICON CARBIDE, OPTIONALLY IN THE PRESENCE OF A SECOND CARBON SOURCE

(76) Inventors: Juergen Erwin Lang, Karlsruhe (DE); Hartwig Rauleder, Rheinfelden (DE); Ekkehard Mueh, Rheinfelden (DE)

(21) Appl. No.: 13/059,692

(22) PCT Filed: Aug. 4, 2009
(86) PCT No.: PCT/EP2009/060068

§ 371 Date: Feb. 18, 2011

(30) Foreign Application Priority Data
Aug. 19, 2008 (DE) 10 2008 041 334.8

(51) Int. Cl. C01B 33/021; C01B 31/36

(52) U.S. Cl. 423/345; 423/349

(57) ABSTRACT

The invention relates to a method for producing silicon by reacting silicon oxide at an elevated temperature, silicon carbide and, optionally, a second carbon source being added to the reaction mixture. The invention further relates to a composition that can be used in the disclosed method. The essential part of the invention is the use of silicon carbide as a reaction initiator and/or reaction accelerator during the production of silicon or, alternatively, in nearly equimolar amounts for the production of silicon.

The invention relates to a process for preparing silicon by converting silicon oxide at elevated temperature, by adding silicon carbide and optionally a second carbon source to the reaction mixture. The invention further discloses a composition which can be used in the process according to the invention. The core of the invention is the use of silicon carbide as a reaction starter and/or reaction accelerant in a catalytic amount in the preparation of silicon or, in an alterative, in approximately equimolar amounts for preparation of silicon.

A known method for preparation of silicon is to reduce silicon dioxide in the presence of carbon according to the following reaction equation (Ullmann's Encyclopedia of Industrial Chemistry, Vol. A 23, pages 721-748, 5th edition, 1993 VCH Weinheim).

SiO₂+2C→Si+2CO

In order that this reaction can proceed, very high temperatures, preferably above 1700° C., are required, which are achieved, for example, in a light arc furnace. In spite of the high temperatures, this reaction begins very slowly and also proceeds subsequently at a low rate. Owing to the associated long reaction times, the process is energy-intensive and costly.

If the silicon is to be used for solar applications or in microelectronics, for example for preparation of high-purity silicon by means of epitaxy, or silicon nitride (SiN), silicon oxide (SiO), silicon oxynitride (SiON), silicon oxycarbide (SiOC) or silicon carbide (SiC), the silicon produced has to meet particularly high demands on its purity. This is especially true in the case of production of thin layers of these materials. In the field of use mentioned, even impurities in the starting compounds in the (μg/kg) ppb to ppt range are troublesome. In general, the silicon is converted beforehand to halosilanes, which are then converted to high-purity semiconductor silicon or solar silicon, for example in a CVD (chemical vapour deposition) process at about 1100° C. Common to all industrial applications are the very high purity demands on the halosilanes to be converted, the contamination of which may be at most in the region of a few mg/kg (ppm range), and in the semiconductor industry in the region of a few μg/kg (ppb range).

Owing to their electronic properties, elements of groups III and V of the Periodic Table are particularly disruptive, and so the limits of a contamination in the silicon are particularly low for these elements. For pentavalent phosphorus and arsenic, for example, the doping of the silicon prepared that they cause, as an n-type semiconductor, is problematic. Trivalent boron likewise leads to undesired doping of the silicon prepared, such that a p-type semiconductor is obtained. For example, there is solar grade silicon (Si_{sg}), which has a purity of 99.999% (5 9s) or 99.9999% (6 9s). The silicon suitable for producing semiconductors (electronic grade silicon, Si_{eg}) requires an even higher purity. For these reasons, even the metallurgic silicon from the reaction of silicon oxide with carbon should satisfy high purity demands in order to minimize subsequent complex purification steps by virtue of entrained halogenated compounds, such as boron trichloride, in the halosilanes for preparing silicon (Si_{sg} or Si_{eg}). Particular difficulties are caused by contamination with boron-containing compounds, because boron in the silicon melt and in the solid phase has a partition coefficient of 0.8 and is therefore virtually impossible to remove from silicon by zone melting (DE 2 546 957 A1).

Generally known from the prior art are processes for preparing silicon. For instance, DE 29 45 141 C2 describes the reduction of porous glass bodies composed of SiO₂ in a light arc. The carbon particles required for reduction may be intercalated into the porous glass bodies. The silicon obtained by means of the process disclosed is suitable, at a boron content of less than 1 ppm, for producing semiconductor components.

DE 30 13 319 discloses a process for preparing silicon of a specific purity, proceeding from silicon dioxide and a carbon-containing reducing agent, such as carbon black, with specification of the maximum boron and phosphorus content. The carbon-containing reducing agent was used in the form of tablets with a high-purity binder, such as starch.

It was an object of the present invention to enhance the economic viability of the process for preparing silicon, by discovering for this process a reaction starter and reaction accelerant which does not have the disadvantages mentioned. At the same time, the reaction starter and/or reaction accelerant should be as pure and inexpensive as possible.

Particularly preferred reaction starters and/or reaction accelerants should themselves not introduce any troublesome impurities, or preferably only impurities in very small amounts, into the silicon melt for the reasons mentioned at the outset.

The object is achieved by the process according to the invention and the inventive composition according to the features of Claims 1 and 9, and by the inventive use according to Claims 14 and 15. Preferred embodiments can be found in the dependent claims and in the description.

The process according to the invention can be performed in various ways; according to a particularly preferred variant, a silicon oxide, especially silicon dioxide, is converted at elevated temperature, by adding silicon carbide to the silicon oxide or adding silicon carbide to the process in a composition comprising silicon oxide; in this case, it is particularly preferred when the silicon oxide, especially the silicon dioxide, and the silicon carbide are added in an approximately stoichiometric ratio, i.e. about 1 mol of SiO₂ to 2 mol of SiC for preparation of silicon; more particularly, the reaction mixture for preparation of silicon consists of silicon oxide and silicon carbide.

A further advantage of this process regime is that, by virtue of the addition of SiC, correspondingly less CO is released per unit Si formed. The gas velocity, which crucially limits the process, is thus lowered advantageously. Thus, process intensification is advantageously possible by an SiC addition.

According to a further particularly preferred variant, a silicon oxide, especially silicon dioxide, is converted at elevated temperature, by adding silicon carbide and a second carbon source to the silicon oxide, or converting silicon carbide and a second carbon source in a composition comprising silicon oxide. In this variant, the concentration of silicon carbide can be lowered to such an extent that it acts more as a reaction starter and/or reaction accelerant and less as a reactant. It is preferably also possible in the process to react about 1 mol of silicon dioxide with about 1 mol of silicon carbide and about 1 mol of a second carbon source.

According to the invention, the silicon carbide is added to the silicon oxide in the process for preparing silicon by conversion of silicon oxide at elevated temperature or optionally added in a composition comprising silicon oxide; more particularly, the energy source used is an electrical light arc. The core of the invention is to add a silicon carbide as a reaction starter and/or reaction accelerant and/or as a reactant, and/or to add it to the process in a composition. The silicon carbide is thus supplied separately to the process. Silicon carbide is preferably added to the process or to the composition as a reaction starter and/or reaction accelerant. Since silicon carbide self-decomposes only at temperatures of about 2700 to 3070° C., it was surprising that it can be added to the process for preparing silicon as a reaction starter and/or reaction accelerant or as a reactant. Completely surprisingly, it was observed in one experiment that, after ignition of an electrical light arc, the reaction between silicon dioxide and carbon, especially graphite, which starts up and proceeds very slowly, increased significantly within a short time as a result of the addition of small amounts of pulverulent silicon carbide. The occurrence of luminescence phenomenon was observed, and the entire subsequent reaction surprisingly continued with intense bright luminescence, more particularly up to the end of the reaction.

The second carbon source is defined as compounds or materials which do not consist of silicon carbide, do not have any silicon carbide or do not contain any silicon carbide. The second carbon source thus does not consist of silicon carbide, has no silicon carbide or does not contain any silicon carbide. The function of the second carbon source is more that of a pure reactant, whereas the silicon carbide is also a reaction starter and/or reaction accelerant. Useful second carbon sources include especially sugar, graphite, coal, charcoal, carbon black, coke, hard coal, brown coal, activated carbon, petcoke, wood as woodchips or pellets, rice husks or stalks, carbon fibres, fullerenes and/or hydrocarbons, especially gaseous or liquid hydrocarbons, and also mixtures of at least two of the compounds mentioned, provided that they have suitable purity and do not contaminate the process with undesired compounds or elements. The second carbon source is preferably selected from the compounds mentioned. The contamination of the second carbon source with boron and/or phosphorus, or for boron- and/or phosphorus-containing compounds, should be less than 10 ppm for boron, especially between 10 ppm and 0.001 ppt, and less than 20 ppm for phosphorus, especially between 20 ppm and 0.001 ppt, in parts by weight. The ppm, ppb and/or ppt data should be understood throughout as proportions of the weights in mg/kg, μg/kg, etc.

Preferably, the boron content is between 7 ppm and 1 ppt, preferably between 6 ppm and 1 ppt, more preferably between 5 ppm and 1 ppt or less, for example between 0.001 ppm and 0.001 ppt, preferably in the region of the analytical detection limit. The phosphorus content should preferably be between 18 ppm and 1 ppt, preferably between 15 ppm and 1 ppt, more preferably between 10 ppm and 1 ppt or lower. The phosphorus content is preferably in the region of the analytical detection limit. Generally, these limits are pursued for all reactants or additives of the process, in order to be suitable for preparing solar and/or semiconductor silicon.

Suitable silicon oxides generally include all compounds and/or minerals containing a silicon oxide, provided that they have a purity suitable for the process and hence for the process product and do not introduce any disruptive elements and/or compounds into the process or burn with a residue. As detailed above, compounds or materials comprising pure or high-purity silicon oxide are used in the process. The contamination of the silicon oxide with boron and/or phosphorus, or for boron- and/or phosphorus-containing compounds, should be less than 10 ppm for boron, especially between 10 ppm and 0.001 ppt, and less than 20 ppm for phosphorus, especially between 20 ppm and 0.001 ppt. Preferably, the boron content is between 7 ppm and 1 ppt, preferably between 6 ppm and 1 ppt, more preferably between 5 ppm and 1 ppt or lower, or, for example, between 0.001 ppm and 0.001 ppt, preferably in the region of the analytical detection limit. The phosphorus content of the silicon oxides should preferably be between 18 ppm and 1 ppt, preferably between 15 ppm and 1 ppt, more preferably between 10 ppm and 1 ppt or lower. The phosphorus content is preferably in the region of the analytical detection limit.

Particularly suitable silicon oxides are quartz, quartzite and/or silicon oxides prepared in a customary manner. These may be the silicon dioxides which occur in crystalline polymorphs, such as moganite (chalcedone), α-quartz (low quartz), β-quartz (high quartz), tridymite, cristobalite, coesite, stishovite or else amorphous SiO₂. In addition, it is possible with preference to use silicas, especially precipitated silicas or silica gels, fumed SiO₂, fumed silica or silica in the process and/or the composition. Typical fumed silicas are amorphous SiO₂ powders of average diameter 5 to 50 nm and with a specific surface area of 50 to 600 m²/g. The above list should not be considered to be exclusive; the person skilled in the art will appreciate that it is also possible to use other silicon oxide sources suitable for the process in the process and/or the composition.

The silicon oxide, especially SiO₂, can be initially charged and/or used in pulverulent form, in particulate form, in porous form, in foamed form, as an extrudate, as a pressing and/or as a porous glass body, optionally together with further additives, especially together with the second carbon source and/or silicon carbide, and optionally a binder and/or shaping assistant. Preference is given to using a pulverulent porous silicon dioxide as a shaped body, especially in an extrudate or pressing, more preferably together with the second carbon source in an extrudate or pressing, for example in a pellet or briquette. In general, all solid reactants, such as silicon dioxide, silicon carbide and if appropriate the second carbon source, should be used in the process or be in the composition in a form which offers the greatest possible surface area for the progress of the reaction.

Preference is given to using silicon oxide, especially silicon dioxide, and silicon carbide and if appropriate a second carbon source in the process in the molar ratios and/or percentages by weight specified below, where the figures may be based on the reactants and especially on the reaction mixture in the process: For 1 mol of a silicon oxide, for example silicon monoxide, such as Patinal®, it is possible to add about 1 mol of a second carbon source and silicon carbide in small amounts as reaction starters or reaction accelerants. Customary amounts of silica carbide as a reaction starter and/or reaction accelerant are, for instance 0.0001% by weight to 25% by weight, preferably 0.0001 to 20% by weight, more preferably 0.0001 to 15% by weight, especially 1 to 10% by weight, based on the total weight of the reaction mixture, especially comprising silicon oxide, silicon carbide and a second carbon source, and if appropriate further additives.

It may likewise be particularly preferred to add to the process, for 1 mol of a silicon oxide, especially silicon dioxide, about 1 mol of silicon carbide and about 1 mol of a second carbon source. When a silicon carbide comprising carbon fibres or similar additional carbon-containing compounds is used, the amount of second carbon source in mole can be lowered correspondingly.

For 1 mol of silicon dioxide, it is possible to add about 2 mol of a second carbon source and silicon carbide in small amounts as a reaction starter or reaction accelerant. Typical amounts of silicon carbide as a reaction starter and/or reaction accelerant are about 0.0001% by weight to 25% by weight, preferably 0.0001 to 20% by weight, more preferably 0.0001 to 15% by weight, especially 1 to 10% by weight, based on the total weight of the reaction mixture, especially comprising silicon oxide, silicon carbide and a second carbon source and if appropriate further additives.

According to a preferred alternative, for 1 mol of silicon dioxide, about 2 mol of silicon carbide can be used as a reactant in the process, and a second carbon source may optionally be present in small amounts. Typical amounts of the second carbon source are about 0.0001% by weight to 29% by weight, preferably 0.001 to 25% by weight, more preferably 0.01 to 20% by weight, most preferably 0.1 to 15% by weight, especially 1 to 10% by weight, based on the total weight of the reaction mixture, especially comprising silicon dioxide, silicon carbide and a second carbon source, and optionally further additives.

In stoichiometric terms, silicon dioxide in particular can be reacted according to the following reaction equations with silicon carbide and/or a second carbon source:

SiO₂+2C→Si+2CO

SiO₂+2SiC→3Si+2CO

or

SiO₂+SiC+C→2Si+2CO

or

SiO₂+0.5SiC+1.5C→1.5Si+2CO

or

SiO₂+1.5SiC+0.5C→2.5Si+2CO

etc.

Because the silicon dioxide can react in the molar ratio of 1 mol with 2 mol of silicon carbide and/or the second carbon source, it is possible to control the process via the molar ratio of silicon carbide and of the second carbon source. Silicon carbide and the second carbon source should preferably be used in the process or be present in the process together in an approximate ratio of 2 mol to 1 mol of silicon dioxide. The 2 mol of silicon carbide and if appropriate of the second carbon source may thus be composed of 2 mol of SiC to 0 mol of second carbon source up to 0.00001 mol of SiC to 1.99999 mol of second carbon source (C). The ratio of silicon carbide to the second carbon source preferably varies within the stoichiometric about 2 mol for reaction with about 1 mol of silicon dioxide according to Table 1:

TABLE 1

| | Silicon dioxide | Silicon carbide (SiC) | Second carbon |
|---|---|---|---|
| Reaction: | in mol | in mol | source (C) in mol |
| No. 1 | 1 | 2 | 0 |
| No. 2 | 1 | 1.99999 | 0.00001 |
| | | to | to |
| No. ∞ | 1 | 0.00001 | 1.9999 |

where SiC + C together always
adds up to about 2 mol.

For example, the 2 mol of SiC and optionally C are composed of 2 to 0.00001 mol of SiC and 0 to 1.99999 mol of C, especially of 0.0001 to 0.5 mol of SiC and 1.9999 to 1.5 mol of C, preferably 0.001 to 1 mol of SiC and 1.999 to 1 mol of C, more preferably 0.01 to 1.5 mol of SiC and 1.99 to 0.5 mol of C, and it is especially preferred to use 0.1 to 1.9 mol of SiC and 1.9 to 0.1 mol of C for about 1 mol of silicon dioxide in the process according to the invention.

Useful silicon carbides for use in the process according to the invention or the inventive composition may be all polytype phases; the silicon carbide may optionally be coated with a passivating layer of SiO₂. Individual polytype phases with different stability can be used with preference in the process, because they make it possible, for example, to control the course of the reaction or the start of the reaction in the process. High-purity silicon carbide is colourless and is used with preference in the process. In addition, the silicon carbide used in the process or in the composition may be technical SiC (carborundum), metallurgic SiC, SiC binding matrices, open-porous or dense silicon carbide ceramics, such as silicatically bound silicon carbide, recrystallized SiC (RSiC), reaction-bound, silicon-infiltrated silicon carbide (SiSiC), sintered silicon carbide, hot (isostatically) pressed silicon carbide, (HpSiC, HiPSiC) and/or liquid phase-sintered silicon carbide (LPSSiC), carbon fibre-reinforced silicon carbide composite materials (CMC, ceramic matrix composites) and/or mixtures of these compounds, with the proviso that the contamination is sufficiently low that the silicon prepared is suitable for preparing solar silicon and/or semiconductor silicon.

The contamination of the silicon carbide with boron and/or phosphorus or with boron- and/or phosphorus-containing compounds is preferably less than 10 ppm for boron, especially between 10 ppm and 0.001 ppt, and less than 20 ppm for phosphorus, especially between 20 ppm and 0.001 ppt. The boron content in the silicon carbide is preferably between 7 ppm and 1 ppt, preferably between 6 ppm and 1 ppt, more preferably between 5 ppm and 1 ppt or lower, or, for example, between 0.001 ppm and 0.001 ppt, preferably in the region of the analytical detection limit. The phosphorus content of a silicon carbide should preferably be between 18 ppm and 1 ppt, preferably between 15 ppm and 1 ppt, more preferably between 10 ppm and 1 ppt or lower. The phosphorus content is preferably in the region of the analytical detection limit.

Since silicon carbides are increasingly being used as a composite material, for example for producing semiconductors, brake disc materials or heat shields, and also further products, the process according to the invention and the inventive composition offer a means of recycling these products in an elegant manner after use, or the waste or rejects obtained in the course of production thereof. The sole prerequisite for the silicon carbides to be recycled is a purity sufficient for the process, preference being given to recycling silicon carbides which satisfy the above specification with regard to boron and/or phosphorus.

The silicon carbide can be added to the process a) in pulverulent form, in particulate form and/or in piece form, and/or b) present in a porous glass, especially quartz glass, in an extrudate and/or pressing, such as pellet or briquette, optionally together with further additives. Further additives may, for example—but not exclusively—be silicon oxides or the second carbon source, such as sugar, graphite, carbon fibres and processing aids, such as binders.

All reaction participants, i.e. the silicon oxide, silicon carbide and if appropriate the second carbon source, can each be added to the process separately, or continuously or batchwise in compositions. The silicon carbide is preferably added in such amounts over the course of the process that a particularly economically viable process regime is achieved. It may therefore be advantageous when the silicon carbide is added continuously and stepwise in order to maintain lasting acceleration of the reaction.

The reaction is effected in customary melting furnaces for preparing silicon, such as metallurgical silicon, or other suitable melting furnaces, for example induction furnaces. The design of such melting furnaces, especially preferably electrical furnaces, which use an electrical light arc as the energy source are sufficiently well known to those skilled in the art and do not form part of this application. Direct current furnaces have one melting electrode and one base electrode, and alternating current furnaces typically have three melting electrodes. The light arc length is regulated by means of an electrode regulator. The light arc furnaces are generally based on a reaction chamber made of refractory material, in the lower region of which liquid silicon can be tapped off or discharged. The raw materials are added in the upper region, in which the graphite electrodes for generating the light arc are also arranged. These furnaces are usually operated at temperatures in the region of 1800° C. It is additionally known to those skilled in the art that the furnace internals themselves must not contribute to contamination of the silicon prepared.

The process can be performed in such a way that
a) the silicon carbide and silicon oxide, especially silicon dioxide, and optionally the second carbon source are each supplied separately to the process, especially to the reaction chamber, and are optionally subsequently mixed, and/or
b) the silicon carbide is added to the process together with silicon oxide, especially silicon dioxide, and optionally the second carbon source in one composition and/or
c) the silicon oxide, especially silicon dioxide, is added to the process together with the second carbon source in one composition, especially in the form of an extrudate or pressing, preferably as a pellet or briquette, and/or
d) the silicon carbide is added or supplied to the process in one composition with the second carbon source. This composition may comprise a physical mixture, an extrudate or pressing, or else a carbon fibre-reinforced silicon carbide.

As already detailed for the silicon carbide, the silicon carbide and/or silicon oxide and if appropriate the second carbon source can be supplied to the process as a material to be recycled. The sole prerequisite on all compounds to be recycled is that they possess a sufficient purity to form silicon from which solar silicon and/or semiconductor silicon can be prepared in the process. Possible silicon oxides for recycling include quartz glasses, for example broken glass. To name just a few, these may be Suprasil, SQ 1, Herasil, Spektrosil A. The purity of these quartz glasses can be determined, for example, via the absorptions at particular wavelengths, such as at 157 nm or 193 nm. As the second carbon source, it is possible to use, for example, virtually spent electrodes which have been converted to a desired form, for example as a powder.

The silicon prepared or obtained by the process according to the invention is preferably suitable a) for further processing in the processes for preparing solar silicon or semiconductor silicon, or b) as solar silicon or semiconductor silicon.

The contaminations of the silicon prepared with boron- and/or phosphorus-containing compounds should be in the range from less than 10 ppm to 0.0001 ppt for boron, especially in the range from 5 ppm to 0.0001 ppt, preferably in the range from 3 ppm to 0.0001 ppt or more preferably in the range from 1 ppb to 0.0001 ppt, reported in parts by weight. The phosphorus content should be within the range from less than 10 ppm to 0.0001 ppt, especially in the range from 5 ppm to 0.0001 ppt, preferably in the range from 3 ppm to 0.0001 ppt or more preferably in the range from 1 ppb to 0.0001 ppt, reported in parts by weight. There is generally no lower limit for the range of contamination, which is instead determined solely by the current detection limits of the analytical methods. For the detection of boron- and/or phosphorus-containing compounds, possible methods include ICP-MS or else spectral analysis or resistance measurements.

The invention also provides a composition which is especially suitable for use in the present process for preparing silicon and whose quality is preferably suitable as solar silicon or for preparing solar silicon and/or semiconductor silicon, said composition comprising silicon oxide and silicon carbide and optionally a second carbon source. Useful silicon oxide, especially silicon dioxide, silicon carbide and if appropriate second carbon sources include especially those mentioned above; they preferably also meet the purity requirements detailed above.

The silicon carbide may also be present in the composition, according to the above remarks, a) in pulverulent form, in particulate form and/or in piece form, and/or b) present in a porous glass, especially quartz glass, in an extrudate and/or pellet, optionally together with further additives. In further embodiments, the composition may comprise silicon-infiltrated silicon carbide and/or silicon carbide comprising carbon fibres. These compositions are preferable when corresponding silicon carbides are to be sent to recycling because they cannot be used in another way, for example production rejects or spent products. When the purity is sufficient for the process according to the invention, it is possible in this way to send silicon carbides, silicon carbide ceramics, such as hotplates, brake disc material, back to recycling. In general, these products, as a result of the production, already have sufficient purity. The invention may therefore also provide the recycling of silicon carbides in a process for preparing silicon.

Accordingly, the silicon oxide, especially SiO₂, may also be present in the composition in pulverulent form, in particulate form, in porous form, in foamed form, as an extrudate, as a pellet and/or as a porous glass body, optionally together with further additives, especially together with the second carbon source and/or silicon carbide. Preference is given to a composition in which the silicon oxide is present together with the second carbon source in the form of extrudates, more preferably as pellets.

The invention further also provides for the use of silicon carbide according to any of the preceding claims as a reaction starter and/or reaction accelerant in the preparation of silicon or the use of silicon carbide in approximately equimolar amounts in relation to the silicon oxide or especially in accordance with an above-specified ratio of silicon oxide to SiC and C for preparing silicon, especially for preparing solar silicon, preferably as a crude product for preparing solar silicon and/or semiconductor silicon. The invention likewise provides for the use of the silicon prepared by the process according to the invention as a base material for solar cells and/or semiconductors, or especially as a starting material for preparing solar silicon.

The invention also provides a kit comprising separate formulations, especially in separate containers, such as vessels, pouches and/or cans, especially in the form of an extrudate and/or powder of silicon oxide, especially silicon dioxide, silicon carbide and/or the second carbon source, especially for use according to the above remarks. It may be preferred when the silicon oxide is present in the kit directly with the second carbon source as an extrudate, especially as pellets, in one container, and the silicon carbide as powder in a second container.

The examples which follow illustrate the present invention in detail, without limiting the invention to these examples.

### EXAMPLE 1

SiO₂ (AEROSIL® OX 50) and C (graphite) were reacted in a weight ratio of approx. 75:25 in the presence of SiC.

Process procedure: an electrical light arc which serves as the energy source is ignited in a manner known per se. A creeping commencement of the reaction is observed through the exit of gaseous compounds between SiO₂ and C. Subsequently, pulverulent 1% by weight of SiC in is added. After a very short time, a very great increase in the reaction is observed by the occurrence of luminescence phenomena. Subsequently, the reaction, after the addition of SiC, proceeded even further with intense, bright orange luminescence (approx. 1000° C.). The solid obtained after the reaction had ended was identified as silicon on the basis of its typical dark brown colour (M. J. Mulligan et al. Trans. Soc. Can. [3] 21 III [1927] 263/4; Gmelin 15, Part B p. 1 [1959]), and by means of scanning electron microscopy (SEM).

### EXAMPLE 2

SiO₂ (AEROSIL® OX 50) and C were reacted in a weight ratio of approx. 65:35 in the presence of SiC.

Process procedure: an electrical light arc which serves as the energy source is ignited in a manner known per se. The reaction between SiO₂ and C begins in a creeping manner. The occurrence of gases is evident. 1% by weight of pulverulent SiC is added; after a short time, this leads to a significant increase in the reaction, discernible by the occurrence of luminescence phenomena. After addition of SiC, the reaction proceeded further for a while with intense, flickering luminescence. The solid obtained after the reaction had ended was identified as silicon by means of SEM and EDX analysis (energy-dispersive X-ray spectroscopy).

### COMPARATIVE EXAMPLE

SiO₂ (AEROSIL® OX 50) and C were reacted as a 65:35 mixture at high temperature (>1700° C.) in a tube. The reaction barely started and proceeded without any noticeable progress. No bright luminescence was observed.

1. Process for preparing silicon by converting silicon oxide at elevated temperature, characterized in that
silicon carbide is added to the silicon oxide or added in a composition comprising silicon oxide.

2. Process according to claim 1, characterized in that
a second carbon source is additionally added or is present in the composition.

3. Process according to either of claims 1 and 2, characterized in that
the silicon oxide is silicon dioxide.

4. Process according to any of claims 1 to 3, characterized in that
the silicon carbide is added as a reaction starter and/or reaction accelerant and/or as a reactant.

5. Process according to any of claims 1 to 4, characterized in that
silicon carbide is added
a) in pulverulent, granular and/or piece form and/or
b) present in a porous glass, or in an extrudate and/or pressing, optionally together with further additives.

6. Process according to any of claims 1 to 5, characterized in that
a) the silicon carbide and silicon oxide and optionally the second carbon source are each supplied separately to the process and are optionally subsequently mixed, and/or
b) the silicon carbide is added to the process together with silicon oxide and optionally the second carbon source in one composition and/or
c) the silicon oxide is added to the process together with the second carbon source in one composition and/or
d) the silicon carbide is added to the process in one composition with the second carbon source.

7. Process according to any of claims 1 to 6, characterized in that
silicon carbide and/or silicon oxide and optionally the second carbon source are supplied to the process as material to be recycled.

8. Process according to any of claims 1 to 7, characterized in that
the silicon is suitable
a) for further processing in the processes for preparing solar silicon or semiconductor silicon or
b) as solar silicon or semiconductor silicon.

9. Composition suitable for use in a process according to any of claims 1 to 8 characterized in that
the composition comprises silicon oxide and silicon carbide, and optionally a second carbon source.

10. Composition according to claim 9, characterized in that
the silicon oxide is silicon dioxide.

11. Composition according to claim 9 or 10, characterized in that,
silicon carbide is present
a) in pulverulent, granular and/or piece form and/or
b) in a porous glass, in an extrudate and/or pressing, optionally together with further additives.

12. Composition according to any of claims 9 to 11, characterized in that
the silicon oxide is present in pulverulent form, in particulate form, in porous form, in foamed form, as an extrudate, as a pressing and/or as a porous glass body, optionally together with further additives, especially together with the second carbon source and/or silicon carbide.

13. Composition according to any of claims 9 to 12, characterized in that
the composition comprises silicon-infiltrated silicon carbide and/or silicon carbide comprising carbon fibres.

14. Use of silicon carbide according to any of the preceding claims as a reaction starter and/or reaction accelerant in the preparation of silicon or in approximately equimolar amounts for preparation of silicon.

15. Use of the silicon prepared according to claims 1 to 8 as a base material for solar cells and/or semiconductors.

16. Kit comprising separate formulations, especially extrudates and/or powders of silicon oxide, silicon carbide and/or the second carbon source, especially in the process or for the use according to any of the preceding claims.
